(19) United States
(12) Patent Application Publication
(10) Pub. No.: US 2017/0308820 A1
(43) Pub. Date: Oct. 26, 2017

(54) SYSTEM, METHOD AND PROCESS FOR EVENT MANAGEMENT AND SERVICES RELATED THERETO

(71) Applicant: NSA INVESTMENTS (AUST) PTY LTD, New South Wales (AU)

(72) Inventor: Nikki AMANTE, New South Wales (AU)

(21) Appl. No.: 15/491,873

(22) Filed: Apr. 19, 2017

(30) Foreign Application Priority Data
Apr. 21, 2016 (AU) 2016901482
Jul. 27, 2016 (AU) 2016902952

(51) Int. Cl. G06Q 10/02; G06Q 30/02; G06Q 30/06; G06Q 50/18

(52) U.S. Cl. CPC G06Q 10/02; G06Q 50/18; G06Q 30/0273; G06Q 30/0601

(57) ABSTRACT

System and method for arranging an event for a subject. The system comprises a portal configured to allow a user to input data relating to predetermined personal information of the user, a theological preference of a subject, a location of the event on a predetermined date. The access portal allows the user to make a purchase from a vendor. The system is configured to provide options for purchases relevant only to the combination of a theological preference and a location of the event. The method comprises; uploading via a portal a data set for the location of the event and a predetermined date of the event, entering in the portal a theological preference of a subject to which the event may be related to; and selecting a purchase option for an event from a vendor, wherein the purchase option is displayed based on the location of the event and the theological preference.

### CROSS-REFERENCE TO RELATED APPLICATIONS

Australian Patent Application No. 2016901482, filed on Apr. 21, 2016, and Australian Patent Application No. 2016902952, filed on Jul. 27, 2016, are incorporated herein by reference in their entirety.

### TECHNICAL FIELD

The present invention relates to a system and method for arranging an event for a subject. More particularly, the present disclosure is directed towards a system for providing and organising funeral services, products and other product services related thereto for a single point of sale and planning. However, it will be appreciated that this disclosure may have application for other social events, including weddings and the like.

### BACKGROUND

Planning for events, such as a funeral is an expensive and emotional exercise. The funeral planning process is typically time consuming and may further exacerbate emotional distress with the person planning the funeral.

There have previously been a number of systems developed to ease the financial costs, such as insurance policies and pre-pay funeral plans. However, these systems are lacking in a number of respects.

Some of these prior systems allow for person(s) to pre-pay for a funeral service, such that when a time comes which requires said funeral services; the person(s) have already paid for the fees associated with the funeral. However, these systems do not take into consideration other goods and services which may be required to assist with close friends and/or family to deal with loss or other personal issues associated with the death of a friend or family member. Nor do they make it easier to manage the actual funeral.

Further, when pre-paying for a planning service the persons are required to find a funeral vendor which will adhere to personal religious beliefs of the deceased and/or the family, if any at all. Finding a funeral vendor can be difficult, not to mention finding a suitable officiant to undertake funeral proceedings and other related rite services.

Funeral planning is also available to the public without having to meet with funeral home representatives. Some current systems have an interactive website which allows a user to complete a funeral plan which may also offer a user life insurance or funeral insurance.

As disclosed in US Patent Publication No. US2005187779, there are methods for providing products and advice related to funerals to a consumer. This document discusses consumer advice relating to funeral planning and funeral financing, however these methods are only concerned with basic needs for planning and financing a funeral and do not consider all of the needs of a client and does not provide any thought for the wellbeing of the family and/or friends of the deceased.

Other approaches to the funeral industry can be found within US Patent Publication No. US20040204966. This document generally discloses packaging life insurance with customer service during time of need. While packaging insurance with insurance customer service meets some needs of a person while during a time of need, these services do not provide any avenues for a client to obtain services for friends and/or family after funeral services.

Further, US Patent Publication No. US20080065489 provides funeral services and funeral related merchandise, which provides for a membership company providing for memberships and collets a fee from the members. Providers issue merchandise to members at a discounted price relative to the general public.

Yet another system is disclosed in US20090037227 for pre-need funeral services which allow a consumer to select a funeral plan based on a budget.

Studies have shown that there can be a detrimental impact on the lives and wellbeing of friends and family when a friend or family member passes away. This impact may exacerbate aspects of the life of the friend or family member which can lead to depression, anxiety or other mental issues.

Therefore, there is a need to provide a customer more flexibility when selecting aspects for a memorial or funeral service. Further, there is a need to provide assistance to aggrieved family members and friends before and after funeral services, as well as access to services for temporary ease of life during time of need.

Any discussion of the prior art throughout the specification should in no way be considered as an admission that such prior art is widely known or forms part of common general knowledge in the field.

### SUMMARY

### Problems to be Solved

It may be an advantage to provide a system or method which allows a user to access counselling services or other care services for their wellbeing.

It may be an advantage to provide a system or method to allow a client to access theological specific options when planning a funeral or memorial.

It may further be an advantage to allow for predetermined time advertisement of death with respect to theological custom.

It may be advantageous to provide access to an all in one system and/or method for planning aspects of a wedding or funeral event and/or memorial service.

It may be advantageous to provide a system and/or method for booking multiple venues, catering, decorations and goods and services associated therewith for a wedding event or funeral event.

There may be a need to provide access to mental health programs during and after an event, such as a wedding or a funeral.

It may be beneficial to provide a system which allows access to legal vendors with respect to funeral arrangement and estate matters.

It is an object of the present invention to overcome or ameliorate at least one of the disadvantages of the prior art, or to provide a useful alternative.

### Means for Solving the Problem

A first aspect the present disclosure may relate to a system for arranging an event for at least one subject. The system may comprise an access portal configured to allow for a user to input data relating predetermined personal information of the user, a theological preference of a subject, a location of the event on a predetermined date. The access portal may be adapted to facilitate the user to make at least one purchase from at least one vendor for the event; and wherein the system may be configured to provide options for the at least one purchase relevant only to the combination of a theological preference and a location of the event in which the purchase may be delivered relative to the date.

Optionally, the system may allow wellbeing and healthcare services to be booked for at least one of; the user, a person associated with the subject and a family member of the subject. The options for purchase may include options related to; advertising, a venue of the event, vehicle hire, a caterer, event specific goods and services, and legal services. Optionally, the legal services includes probate services. Optionally, the system may allow only a predetermined vendor to offer goods and/or services to the user. Optionally, a fee may be charged to at least one of a user and a vendor to use the system. Optionally, the access portal may be at least one of a mobile application, a web portal, and an Internet webpage. The options for the at least one purchase may include a biodegradable product which may comprise at least one of the materials selected from the group of; bio degradable polymers, cardboard, paper, food products, bread, starch based materials, wax, cotton, and wool. Optionally, ashes from a subject may be used to form an embedded product. Optionally, embedded product may be at least one of a statue and a toilet seat. Optionally, an event is selected from the group of; funerals, weddings, birthdays, anniversaries, house warmings, baby showers, christenings, religious specific events, bar mitzvahs, bat mitzvahs and divorce celebrations.

In another aspect, the present disclosure may relate to a method for arranging an event for a subject. The method may comprise the steps of; uploading via a portal at least one data set for the location of the event and a predetermined date on which to have the event, entering in the portal a theological preference of a subject to which the event may be related to; and selecting at least one purchase option for an event from at least one vendor, wherein the at least one purchase option may be displayed to a user based on the location of the event and the theological preference of the subject.

Optionally, the method further includes the step of selecting an advertising option in relation to the event. Optionally, the method further includes the step of arranging for an officiant to attend the event. Optionally, the method further includes the step of hiring at least one vehicle for the event. Optionally, the method may further include the step of purchasing at least one of; a casket or a site marker from a predetermined vendor. Optionally, the method may further include the step of a user paying a usage fee to the system. Optionally, the method may further include the step of a vendor paying a usage fee to the system. Optionally, the method may comprise the step of booking at least one wellbeing service for at least one of; a user, an invitee of the event and an attendee of the event.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 depicts a flowchart of an embodiment of a process or method;

FIG. 2 illustrates a flowchart of a further embodiment of a process or method;

FIG. 3 illustrates an embodiment of the system in communication with a user device and at least one vendor; and

FIG. 4 depicts an embodiment of a schematic of the interrelationship of goods and services with the system.

### DETAILED DESCRIPTION

Preferred embodiments of the invention will now be described with reference to the accompanying drawings and non-limiting examples.

In a broad aspect, the system of the present disclosure comprises an access portal for a user, accessible via an electronic device (user device), such that they are able to book and/or arrange goods and services for an event. In the context of this specification, the term event can mean any planned occasion, such as a wedding, christening, baptising event, bar mitzvah, bat mitzvahs, a funeral or the like. It will be appreciated that other services, such as counselling and wellbeing services may be requested or ordered via the system.

An electronic device may include; a computer, a laptop, a smart phone, a tablet device, a smart watch, a touch screen device or any other compatible electronic device which allows a user to interact or otherwise input data. Preferably, the electronic device allows access to the Internet, however it will be appreciated that the system may be adapted operate offline and data may be saved for transfer at a later time, either through a hardware interface or uploaded when an Internet connection or network connection is available.

The access portal is in communication with a server of the system 10 which allows the transfer of data between the electronic device and the server. The server is adapted to store at least one data set input by a user of the portal in a storage means (or database). A storage means may include a solid state drive, a disk drive, a volatile memory, a non-volatile memory or any other suitable storage means.

It will be appreciated that an access portal user is preferably associated with a portal user account. The portal user account may be associated with at least one of a single user, multiple users and/or multiple viewers. Viewers may have limited access to a portal user account and may make small amendments, pay bills or make other predetermined actions, or may be restricted to only viewing selected information associated with the portal user account. This may be advantageous as this may allow a family to access life insurance policies, private information, or other information necessary for funeral services. A portal user account preferably comprises, and may be accessed via entering at least one of, a username, a password, an e-mail address, and/or pin numbers, and may further be utilised to enter credit card information for payment of services and plans as a service, policies, and packages associated with the system.

Generating a user account preferably generates which is associated with the system by providing personal information, which may include, full legal name, gender, date of birth, government issued identifier, marital status, residency and/or citizenship, ethnicity, residential address, will information, trust information, named beneficiary information, information pertaining to immediate family members, and the like. The user account may allow a user access to databases for retrieval of plans, packages, services, merchandise or view purchase history or view a virtual shopping cart.

Through portal or via the website, a user may search for and select vendors, merchandise or goods, and educational materials relating to funerals, memorials or other predetermined services. The system may also offer information or products relating to insurance policies, pre-pay funeral services, or other policies which are relevant to the funeral service or healthcare industries. Preferably, the system allows a user to select the specific vendor location, and the venue or location in which the selected services or goods are required.

Data entered through website or portal, and/or provided to certified pre-need insurance agents via a user service, may be modified otherwise changed by user at user's discretion. It will be appreciated that a time lock may be in place wherein a user may not change or modify purchased goods or services. For example, a time period 24 hours before a funeral service, the goods and services selected may not be amended or altered, however it will be appreciated that the system may allow additional goods or services to be added. Additionally, through website or user service, user or vendor may process payment for subscription services, wherein credit card, cheque payment information may be supplied via online transactions a, or via telephonic transaction with certified pre-need insurance agent. Upon payment for the subscribed services or plans as a service, user is electronically mailed, and hard-mailed, a copy of the pre-need policy and plan.

The system is adapted to determine whether or not a user account is an existing user account. For example, a user account may be associated with an email address and if the email address is already in use, the user account will be identified as an existing user. If the user account does not exist, the user can generate a new user account.

A user can generate a new user account over a network, via a portal, by a website, by telephone, through a certified pre-need agent, a participating vendor and the like. However, for the sake of one embodiment, a portal or website will be the means for generating a user account. If the subscription customer is an existing customer, then the customer can access and modify details, goods and services ordered, request information or otherwise request to purchase goods and/or services. Existing customer can typically access their user account with a user name, password, government issued identifier, Tax File Number (TFN), social security numbers, policy number or the like.

Preferably, the system comprises a search function which may be adapted to allow a user to search for at least one of; merchandise, services, venues, locations, policies, personal records, information or uploaded documents. However, it will be appreciated that an authorisation check may be required prior to allowing access to confidential information in the event that a user account is accidentally logged in. A search function may be provided which allows access to details of the user and/or the deceased. The details may include confidential information, policy information, payment schedules, merchandise listing, service listing or any other predetermined data set.

A user account may be allowed access to at least one database via a system administrator, wherein the system administrator enables a user the ability to manage aspects relevant to their respective user account. Aspects which can be managed may include data related to; viewing, emailing, printing, policies, purchase history, goods or service, ID cards, checking billing status and online payments, viewing account activity, viewing detailed coverage information, checking claim status, adding or deleting users, beneficiaries, agents, representatives, legal services or requirements, vendors and/or altering provider services and plans as a service, and payment means.

In general, the system preferably includes several security layers that can be changed per customer. For example, a user is typically assigned or may generate at least one user login which is associated with at least one password. Users can preferably view account information, use e-mail, print policies and identification cards, check billing status and make online payments, view account activity, view detailed coverage information, check claim status or review purchase history or order history.

In yet another embodiment, at least one administrator can create view, use email, print policies and identification cards related to a user, check billing status and make online payments for a user, view account activity for a user, view detailed coverage information for a user, check claim status for a user, or provide other desired information to a user. Preferably, system administrators can also add or delete users, agents, representatives, directors, service representatives or any other user predetermined persons or entity associated with the system. Other system users may be at least one of agents, vendors, moderators or any other predetermined user.

A system and method for providing a user with a means for arranging a funeral or a memorial. Arranging a funeral or memorial includes purchasing at least one service or merchandise which is to be used in association with a funeral service. The merchandise and services distributed being dependent on a vendor, group of providers, merchandise providers and having a contractual association with a particular service provider to provide products, transferable services, funeral/memorial policies and the like. In yet a further embodiment, vendors (also herein referred to as goods providers or service providers) are required to pay a subscription fee per predetermined time period to be allowed to retail goods and/or services via the system. In addition, a user may also be required to pay a usage fee to use the system.

The contract and funds will be assigned to the vendor in which payment from the system, either from the user, finance provider or an associated insurer, will be made to the vendor directly and they pay vendors or the contract can be reassigned and the pre-need financial service centre can pay vendors, pay for services, process payments, outsource goods and services an any other processes for the streamlining of vendors operations.

Additionally, a superannuation or social security module of the system enables users to pay into superannuation or social security funds for subsequent application, assignment or disbursement toward their vendor. At least one other module may be associated with the system which allows for payment into education funds and/or pension funds, as well as trust accounts, all of which may be subsequently transferred, conveyed, assigned or otherwise applied to a named-beneficiary, or further made available for the purchase of goods and/or services from a vendor.

A web application, a mobile application or any other suitable application or access portal will preferably be delivered on demand through web applications. Further embodiments may advantageously be implemented in one or more computer programs that are executable on a programmable system including at least one programmable processor coupled to receive data and instructions from, and transmit data and instructions, to a data storage system of a server, at least one input device, and at least one output device. Each application (or computer program) may be implemented in machine language or assembly language which can be assembled or translated, or a high level procedural or object-oriented programming language, which can be complied or interpreted. Suitable processors include, by way of example, both general and special purpose microprocessors. Generally, a processor receives instructions and data from read-only memory and or RAM. However, any suitable computer system may be used by the present disclosure. Further, the system may be adapted to operate on a cloud server such as Amazon Web Services (AWS).

The server is preferably further in communication with at least one vendor, which a user can make a purchase therefrom. More preferably, the system is adapted to be in communication with multiple vendors, which can provide goods and/or services, such that when a user makes a request through the portal the server of the system can relay said request via a communication means to at least one vendor or make a purchase from a vendor. This allows the system to interact quickly with multiple vendors which may accelerate the event planning process. Allowing the system to be in communication with multiple vendors may also allow a user to select more cost appropriate options, or may allow a user to have a bespoke good or service for the funeral or memorial.

Preferably, the system is adapted to be in communication with a third party, such as an insurance provider, a healthcare provider or a government department. It will be appreciated that the system may be in contact with at least one predetermined third party, regulatory bodies and/or government bodies.

In yet a further embodiment, the system is adapted to send/receive data relating to at least one of: an address, a theological preference, public or private advertisement of an obituary or other message, desired funeral parlour selection, casket and site markers selections, venues selections, catering selections, decoration selections, transportation, notifications, official documents, charity services, support service requests, financial service requests, or legal services. Other predetermined data sets may also be received by the system which may relate to the request for goods and services or special requests for time of need. While the system may display options for data input, a user may opt to leave fields unfilled, blank or void of any commitment for purchases. A user may also refuse to fill in data related to the above data sets based on religious preferences or any other preference. Some of the aspects related to these data sets are described further below.

Address

The system is adapted to receive locational data or geographical data from a user such that the system can narrow down options for display to a user. Narrowing options may allow the system to more quickly provide a result for a user of the system, thus reducing wait times. Further, narrowing results can also have the added ease for the user to view only relevant results.

Address details may be at a high level, such as a suburb or state, but may also be more detailed and request specific residential details or business address details such as a street name, postcode, street number, unit or apartment number or any other desired residential location data set.

While geographical information may be provided by a user, the user may optionally select to have a funeral in a different geographical location, such as interstate or another county or, in certain circumstances, other countries. Options for transportation of the deceased may be provided to a user, to arrange a subject to be transported to the desired location.

The system is preferably adapted to only display results to a user which are relevant to an address entered into the system. It will be appreciated that filters may allow a user to expand or restrict searching parameters. In yet a further embodiment, the system does not narrow options displayed to a user based on address data (i.e. locational data or geographical data).

Religion

The system is preferably adapted to allow a user to select a secular memorial or service or a no-religious memorial or service to cater for the deceased or organiser's belief system. The system may be adapted to display a list to a user which identifies common religious belief options, such as Christianity, Judaism, Islam, Hindu or any other predetermined religion.

For the sake of one embodiment, a custom religion may be entered, for example Scientology, Lovecraftian religions or Temple of the Jedi Order. If a custom religion is entered, at least one input field may be provided to a user to enter or upload details for themes, request ceremonial items, colour schemes and other paraphernalia associated therewith.

Based on a religion selection, attendees may be notified if there is a preferred dress code or other religious regalia which may be worn or avoided during the funeral. Further, selecting a religion may also narrow down future options for a user, or restrict potential caterer vendors from providing certain foods. For example, if there is a Jewish funeral shellfish may be excluded from potential catering menus. This may assist in avoiding social faux pas or religion customs conflicts.

If a religion is selected further options for an Officiant to be selected. Preferably, based on both a religion and a geographical location, a list of available Officiants may be displayed to a user. Officiants associated with the system may provide a range of locations in which they are willing to travel to, such that only Officiants willing to attend an event location are displayed to the user. Optionally, the system may allow a name search for a desired Officiant and request that they travel to a desired location. Such a request may be accompanies by, for example, legal documentation, reasons for request, incentives or increased rates for the Officiant. For example, an Officiant who has been with a family for multiple generations may be requested to travel to a further location.

In some circumstances the subject(s) may not have a religion or their religion is unknown, however a user of the system may be adapted to browse and select options related to Officiants or other religious options which can be displayed by the system.

Advertising

Based on religious customs there may be a requirement to advertise a person's death in multiple advertisements or there may be a requirement to display a notification of death in a predetermined format. For example, there may be a requirement for some religions to display advertisements for events or services at known time intervals, such as 9 (nine) days, 40 (forty) days, 3 (three) months, 6 (six) months, 9 (nine) months or 12 (twelve) months, relative to the event or a date which caused the event. It will be appreciated that other predetermined time intervals may also be selected or entered into the system.

Advertising is preferable in a written format, such as that issued via newspaper or online text formats. However, there are instances which require other formats, such as video, to be uploaded or otherwise distributed. For example, a video may be uploaded to a file or video sharing service, such as 4Shared™, YouTube™, Dailymotion™ or Vimeo™, for public or private viewing. When a video or file is posted or otherwise uploaded, a notification may be sent to at least one person notifying them of the video or file. For example, this may allow a person to prerecord videos to be shown after their death which may be of particular value to, for example, persons with a terminal illness. As a further example, a wedding highlight video may be uploaded for messaging other persons or for download by others.

Additional forms of advertising may also be purchased through the system for larger events, for example, radio, cinema adverts, television advertisements, web banners, billboards, skywriting, magazine adverts, town criers, online videos, and online advertisements.

Event Venue Options

Venues such as funeral parlours, funeral homes, crematoriums, mortuaries, churches, mosques, synagogues and the like are typically essential for funerals, memorials, weddings or other religious events. However, it is becoming more common to have alternate venues for events, such as outdoors, on boats, or in residential houses. As such, the desired venue of the user may be selected via the portal.

The system may optionally be adapted to only display funeral parlours relevant to at least one of a filter option and/or input geographical data and/or an address input into the system. Funeral parlour options may further include other venues which are associated with the system or a venue not associated with the system may be manually entered. If a venue not associated with the system is input into the system via the portal, the system may be adapted to contact the venue to request a booking, or the venue details may be located by a representative of the system to book the venue (if available) for the user.

With respect to relatively more celebratory events, such as a wedding or birthday party, other types of venues may be more desirable, such as a park or a recreational venue. As such, the system may be adapted to allow a user to input or select the type of event from a predetermined list, or enter a custom event. Based on the type of event, the system may restrict options for venues or provide more options for a custom event. For example, selecting a birthday party may remove venue options for a funeral parlour.

Casket and Site Markers

A site marker may be at least one of a headstone, a gravestone, a plaque, a stele or any other identification marker. A marker may also include urns, cinerary urns, burial urns, a tree pod or any other receptacle suitable for storing remains.

Further, options for site markers may be provided to a user. In a further embodiment, a user may be able to select at least one of; marker materials, a marker font, an image, a statue or sculpture, colour, texture, pattern, font, font size, embossing, finish, or any other predetermined option for a site marker.

Other burial options may also be provided to a user, such as a burial structure or mausoleum. Optionally, if a family plot or societal burial plot already exists, a standard marker may already be assigned to the plot. In these situations, details of the standard marker may be uploaded via the system interface or retrieved from a memory associated with the system if this information has previously been stored.

In yet another embodiment, the at least one customisation option may be provided to a user such that they may modify, or customise, a casket. Options may include at least one of; selection of desired materials, finishes of said materials, colours, designs, images, logos, electronics, custom dimensions for larger persons, custom fittings or special request entry fields, such that a customer can be contacted by a sales representative to design a custom casket, or part thereof.

In yet a further embodiment, the casket may be an environmentally friendly, such as a Tree Pod™, a biodegradable casket or cardboard casket. This may allow a subject to be buried in a more sustainable manner, relative to more conventional burial means.

Alternative burial options may also be offered to a user of the system. As opposed to standard burial plots, a subject may wish to donate their body for scientific study, organ harvest, arts or research purposes. Typically, the subject will have previously provided consent for their body to be donated and/or provided instructions for such a purpose.

It will be understood in the field of invention that a casket and a coffin are different receptacles for a cadaver, however throughout the specification; these terms have been used interchangeably, but are intended to be interpreted in a broad manner.

For other more joyous occasions, a subject may request other markers, such as a commemorative marker, to remember the occasion, or any other item which may commemorate an event. For example, markers may be fabricated from a personal object or a religious object which relate to the event or have a special meaning. In yet another example, a commemorative marker may be a bench or chair, such as a park bench, which comprises a tribute or plaque. The tribute or plaque can be customised to contain a personal message or any other predetermined message or image. Further, the materials for the bench may be customised, for example, a selection of colours, woods, metals, plastics and the like may be requested by the user.

In yet another embodiment, an urn may be a biodegradable urn in which ashes of a subject may be received. The urn preferably comprises a lid, an urn body optionally a plaque. As the body of the urn is biodegradable, the urn may be adapted to be buried or partially buried. Optionally, the lid is also biodegradable and/or comprises seeds for sprouting a tree or plant as a marker for a subject. The lid may also be adapted to receive a candle in a receiving means on a relatively upper surface of the lid. Biodegradable materials may include, starch based polymers, biodegradable polymers, cardboard, food based materials, bread, organic urns, wax (for example, soybean wax or bees wax), cotton, wool and the like. It will be appreciated that only a portion of the urn may be formed with a biodegradable material.

A bread urn, such as that disclosed in utility model patent DE202007000586 U1, can be formed with a hard crust surface such that the bread can be transported for a period of time before degrading. This also assists with keeping out insects and vermin before the urn is at a desired resting place.

An organic urn may be a living urn pre-grown into a receptacle shape adapted to receive the ashes of a subject. Organic urns may be planted into a designated plot and the ashes of the subject can be used by the plant as nutrients. Another type of organic urn may be a terrarium, in which plants can be grown from the ashes of a subject.

In yet a further embodiment, if a subject is cremated a user may wish to have their ashes embedded into resin or another material to make an embedded product. The embedded product may be an ornamental piece such as a statue, or may be a more purpose driven item, such as a toilet seat.

In another embodiment, ashes may be used as a 3D printing material, or part thereof. The 3D printing material is preferably formed into a bust or likeness of the subject. The bust may be a representation of the face and/or the shoulders of the subject, and may further comprise a message or plaque. Preferably, the plaque is disposed on the bust around the neck portion of the bust.

Venues and Catering

Further venues may also be required as part of an event, such as a venue for a wake or wedding service. Such venues may be separate to an event location or gathering location in which the main object of the event occurs, such as a funeral service or a wedding ceremony.

Other venues may include residential houses, restaurants, public locations, parks, outdoor areas, boats, boat houses, ballrooms, bars, beer gardens, pubs, cocktail bars, event spaces, hotels, meeting rooms, nightclubs, private dining rooms, cafes, rooftop bars, unique venues, warehouse venues and other predetermined venues types.

Catering services for the venue may be optionally selected. Such services may be associated with the venue or otherwise contracted from a secondary source not associated with the venue.

Ceremony or Memorial Decorations

Decoration services may also be required for an event, such as a funeral or memorial service. Decorations for such events are typically floral, religious, ornamental or may have a significant meaning to the subject of the event or members of their family or their friends. However, some events may require a decoration theme or other novelty event to take place. Themes may be for a subject who was young in age, subjects who wished to have a predetermined theme for their event or a religious theme.

For example, a subject young in age may have a theme associated with a favourite television show, movie, book, or pastime activity. This may be of a particular advantage if other young attendees are present for an event. Other themes, such as movie or TV themes may also be desirable by diehard fans of a movie or the like.

Further, a photograph may be uploaded to the system, which may be distributed to family, friends and attendees of the event. The photograph may also be used to generate a portrait of the subject of an event, such that the portrait may be placed in front of the casket or at the front of the event location during the event.

Transportation

Hearses and other transportation arrangements may be required to be made, and depending on the scale of the event. Preferably, the system allows hire of transportation to suit an event, an event location or a desired preference of the subject. Such transportation may include, cars, vans, hearses, horses, carts, boats, planes, yachts, sports cars, classic cars, limousines or any other mode of transportation. Further options, may allow a user to search for makes of transportation or a preferred transportation provider. This may be an advantage if the user has a discount or offer to redeem from a particular vendor or provider.

Customarily, the subject of the event will arrive in a hired vehicle, such as a hearse in the case of a funeral or other predetermined vehicle which is event appropriate which is adapted to transport a subject in a casket. However, it will be appreciated that other means of transportation may also be used, particularly if the subject arrives prior to the attendees of the event.

While transportation to an event is primarily meant for the subject, a user may also book transportation for friends, family or other attendees of the event. It at least one embodiment, the user is also the subject of the event. It will also be appreciated that transportation may not be required for an event.

Notifications

The system may provide a user with contact information regarding the selected services and/or goods. This may allow a user to form a communication between themselves and a provider or vendor. The communication may be at least one of; email, telephone, instant messaging, video link, real-time text, online chat or any other means suitable for communicating between two parties to purchase or book goods and/or services. The notification means may be adapted to allow for transfer of files, clickable hyperlinks, voice chat, video chat or the like.

The system may further be adapted to provide at least one notification related to an event to recipients, such as family, friends and other attendees, of an existing event. These notifications may be in the form of an invitation, an update, or notify recipients of the notification of a desired theme or requirement for the event, for example to arrive at the event in formal wear. Notifications may be automatically generate by the system for predetermined recipients if there are modifications to an event, such as a last minute change of location of the event or a change of event time.

Notifications may also be provided to the user from vendors or providers, such that a user can be updated with planning progress, goods and/or service progress or any other desired information which may impact or be required for an event.

Official Documents

The user portal may further be adapted to send and receive legal data associated the user, a further user, a group of persons, an entity or a deceased person. Uploading legal or confidential documents via the system may be advantageous as the system may relay legal documents to government departments or legal professionals for the purposes of updating public records and settling estates or other outstanding legal matters relating to a subject.

In yet a further embodiment, the system is adapted to communicate with at least one government department, for example births, deaths and marriages, department of health or with other governing bodies such as state, territory or county governments or branches thereof. It will be appreciated that the system may be adapted to communicate with various government bodies or government organisations. Preferably, the government organisations in communication with the system can receive data from the system related to a subject of an event, and/or the government organisations may provide data related to the subject to the system, provided that a user of the system is allowed access to such data.

As there are a number of legal documents typically associated with the death of a subject, the system may provide a means for contacting a probate lawyer such that an estate can be settled or assets be disbursed to family, friend, and any other entity which may derive a right to said assets or estates.

Other organised probate services may also be requested via the system. Organised probate services may assist with wills, probate and death taxes of the subject and the services may ensure that all legal requirements are complied with. In addition, management services or executor services may be employed by the user to deal with other assets or payments, such as pensions, bank accounts, outstanding debts, bills, asset transfers or any other day to day activities that may only be interacted with by the consent of a government body or an authorised entity.

It will be appreciated that the system will have at least one security measure to ensure that data cannot be accessed or extracted from the system without appropriate permissions. The system may be adapted to encrypt data, for example with hashing algorithms or the like. Other firewall securities may also be used to prevent or resist unauthorised parties from accessing confidential or private data on the system.

Charity Services

Optionally, the system may be adapted to allow for charity services or donations to be made through the portal on behalf of the user and/or the deceased. A one off payment or a long term charity payment schemes or schedules may also be initially set up via the system.

If a recurring payment is set up via the system, the payment can be scheduled to occur at any predetermined interval or predetermined time period. For example, a payment can be made on a specific date each month or at a specific day every month, such as the first Saturday of the month. Alternatively, random dates may also be assigned to donate to a charity, which may correspond to important dates of family and/or friends, such as birthdays for example.

In a further embodiment, the system may allow management of the charity payments via the portal, such that if the user of the account wishes to terminate or modify the donations to a charity, they may do so without directly contacting the charity. A message or other notification may be sent to the charity or to payment service to cancel or modify the donations.

The system may also allow a charity to be selected as a gift for a subject. Optionally, a gift registry may be uploaded to the system which is accessible by at least one of the attendees or associated persons of the event.

Support Services

The system may further allow for support services, support groups and counsellors to be contactable via the user portal or contact details may be provided to a user via the portal. Support services may include mental health services, social network services, peer groups, healthcare services and other self-help services. Support service connections may assist a user or family and/or friends of the subject with arranging or organising an event.

In yet a further embodiment, the system may allow a user to set up a temporary or permanent calendar for support services. For example, the system may allow a user to contact cleaning services, shopping services, home maintenance services or other care services.

Other services may also be provided for, such as group outings and other activities. Allowing activity services, such as group outings, may be of particular advantage to elderly family members which may have relied heavily on the deceased for companionship, or family members which wish to interact with persons with a similar emotional experience.

In some situations, the subject may have a number of animals in their care at the time of death. Unfortunately, friends and family may not be able to accept to care for the animals for any number of reasons. As such there may be a need for animal care services or collection to ensure that animals can be cared for and/or put up for adoption by another family.

Government Departments

Preferably, the system is adapted to communicate with at least one government service or government department. The government department may provide additional goods or services to a user, but may also be linked with the system for data collection, such as to record the death of an individual.

Integrating the system of the present disclosure may have a number of advantages, such as notifying all government departments via one system such that family and friends of the user can efficiently notify all relevant governing bodies or regulatory bodies of the death of a subject.

Welfare services or government assistance services may also be contacted by the system to ensure that future payments to the subject are ceased, or payments relating to the subject are altered. For example, a household income for two persons may be $500 per week collectively; however a single person may receive $300. This may ensure that all payments are correct which can reduce the potential for incorrect payments from welfare or government assistance, which may need to be paid back at a later time.

Further, after a funeral event if a subject has superannuation, social security or any other government held funds, the system may be adapted to apply for retrieval of said funds if possible.

Financial Services

As an event and associated purchases can be costly, there may be a need to allow users of the system to apply for short term or relatively small loans to cover event costs and other near future expenses. This may be of particular advantage with respect to funeral events where funds may be needed in the immediate short term.

Loans may be provided by the portal owner or may be provided by at least one third party financier who is sufficiently qualified to provide such a loan. In a further embodiment, the system is adapted to allow a financier to access at least a part of a credit history of a user or person associated with the portal account. A person associated with the portal account may be, for example; a further user, a deceased person, a family member of a deceased person, a family member of a user, a friend of a deceased person, a friend of a user, or any other predetermined person. It will be appreciated that consent will be required by person or entity applying for a loan and any necessary checks, such as identification checks or document checks, will be completed prior to allowing access to confidential information. At least one good or service associated with the system may require a user to upload a scan or certified copy of identification or other form of proof of person or confirmation of identity.

Alternatively, the system may be adapted to allow access to insurance services to cover the fees, or a portion thereof, for funeral services and other related goods and services. It will be appreciated that at least one insurance service profile may be linked to a user account such that when a user requests for funds for an event, such as a funeral, the event may be at least partially paid for by the insurer.

In yet a further embodiment, a running total of all fees is displayed to a user via a display screen of the device. This allows a user to easily track fees associated with the purchases for goods and services. The displayed fees may display an overall total or a split total which shows the exact amount of the fee for a particular good and/or service. For example, the total may be split to illustrate the total cost of goods purchased or in a shopping cart for a predetermined period. The predetermined period may be a time period to present, a time interval(s) therebetween, or a projected costing based on potential future goods or services requested. It will be appreciated that the user of the system may be required to meet predetermined deadlines or be denied access to goods/services or functions of the system.

Payment for goods and services can be by credit card, wire transfer, money transfer, electronic transfer (such as PayPal™), cheque (check), or any other predetermined payment means. Once payment has been received by the system, the goods and/or services can be ordered by the user. In yet a further embodiment, the system may be adapted to bill incremental amounts of a total based on an agreed upon payment schedule. The payment schedule may be required to be set up via correspondence with a representative or can be confirmed by the system based on predetermined schedule options. A surcharge or varying rates may apply to payment schedules.

Further, a user may be offered discounts based on upfront payments or special offers, such as off peak times, friend referrals, or multiple deceased. Other offers or specials may be based on package deals or promotional material.

After payment, preferably at least one of electronic confirmation receipt or a physical receipt is issued to a user and/or delivered to an address input by a user. Said receipt may contain details about all items purchased as well as further optional extras which may be purchased via the system at a later time.

Other Optional System Functions

In yet a further embodiment, the system may allow a user to rate a vendor. Allowing a user to rate the quality of the products may entice further users to source goods and/or services from highly rated companies and reduce the potential for users to attempt to purchase substandard products from vendors with a poor rating.

While options may be available for a user for different services or goods, the system may provide default vendors which are preferred vendors. The preferred vendors may have a reciprocity arrangement for services/goods offered and services/goods provided.

In yet a further embodiment, the deceased may optionally be signed up to a social network. A social network may allow families to build a tribute to deceased persons which may be useful in certain cultures. For example, known customs in Mexico have festivals to celebrate the dead, such as Dia de Muertos. Having a social media profile may allow persons to upload comments, images, videos and other remembrance or prayers to honour (honor) the deceased.

Further to the above, a subject may have a number of animals under their care and if the subject is no longer available to care for these animals an animal service may be required.

The system may also be adapted to request termination, suspension or shut down at least one social media account or profile associated with the subject. For example, a user may upload email addresses or login user names to the system such and contact at least one social media platform with these user names and/or email addresses to request a termination of an account or profile. Such social media platforms may include, but are not limited to, Facebook™, Twitter™, Myspace™, Instagram™ LinkedIn™ or any similar social media account or profile.

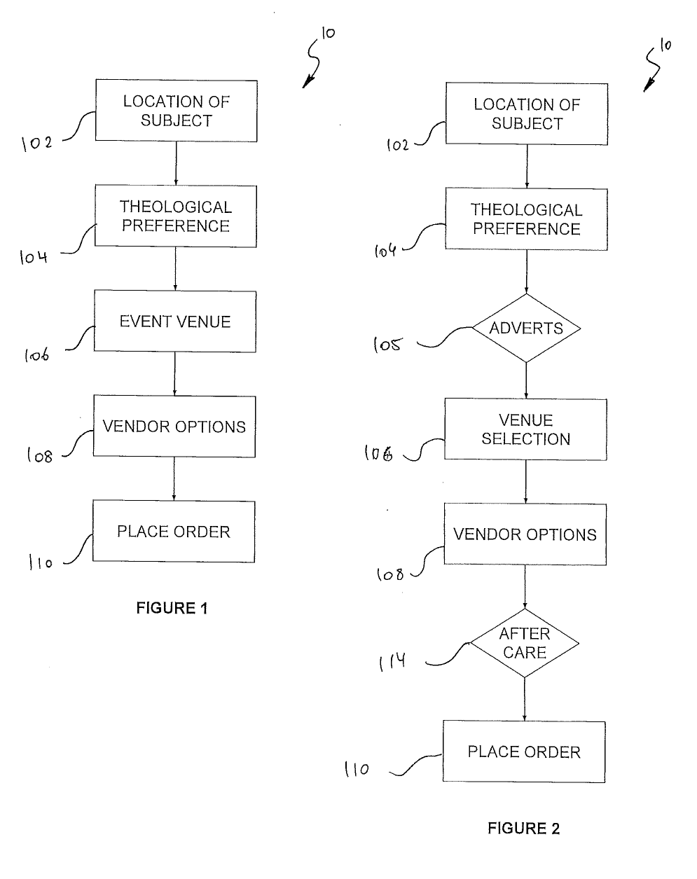

Referring now to FIG. 1, there is depicted a flowchart of an embodiment of the system 10. A user initiating a request for an event and services related thereto, such as a funeral or a wedding, inputs data related to the location of at least one subject. Data can be uploaded or input into the system by at least one user device which has a display screen associated therewith. At a high level, location data or geographical data 102 relating to at least one subject location or can be input, or alternatively the desired final destination of the subject. The geographical data 102 is uploaded to the system 10 via the user interface or user portal 150. The geographical data 102 may restrict search options to only those which are geographically relevant to the subject location.

In this embodiment, the system 10 further comprises an input for a theological preference of the subject 104. The theological preference may be one selected from a predetermined list of theologies, a custom theological preference or if the subject does not have a theological preference, a preference indicating that the user does not have a preference may be entered. Selecting a theological preference and/or a location may narrow the results displayed to a user device display for an event venue.

Event venues displayed to a user for selection 106 may be related to the location of a subject (or location proximal thereto) or a desired location. If a desired location is not proximal to the location of a subject, the user may have the option to select a location which is the desired location. In any case, event venues can be filtered manually by a user or may be displayed in relation to a default filter of the system.

After a user has selected an event venue at least one vendor option 108 is displayed to a user, such that they can purchase goods and/or services related to the event. The goods and services may relate to at least one of public or private advertisement of an obituary or other message, desired funeral parlour selection, casket and site markers selections, venues selections, catering selections, decoration selections, transportation, notifications, official documents, charity services, support service requests, financial service requests, or legal services.

The system may further allow signing of an electronic guestbook or have a guestbook uploaded after an event, such that attendees can see well wishes or other messages written therein. Other suitable ledgers may also be provided for an event if the user requests such a book to be present. After the user has selected all desired purchased for goods and services, the user proceeds to place the order 110.

Yet a further embodiment is illustrated in FIG. 2 which provides a user with more options relative to FIG. 1 in which a user can select an option to purchase advertisements 105. Advertisements 105 can be placed on behalf of a subject, such as a wedding notice, an obituary or an open invitation for an event in a newspaper or online advert. In addition, as an event may be associated with a strong emotional stress, such as a funeral event, the system preferably has an avenue for a user to request after care services 114. After care services may assist with the quality of living of the user and may reduce the potential for mental illness to form. For example, a user may request cleaning and cooking services for a period of time proximal the time of an event to reduce the stresses of living. Further, the system may allow for group therapy sessions to be booked or signed up for, such as group outings with persons who have undergone similar experiences or may be a health care professional who is qualified to assist with grieving or other potentially stressful emotions. It will be appreciated that after care services may be requested after an initial purchase if the user reconsiders purchase of these goods and services.

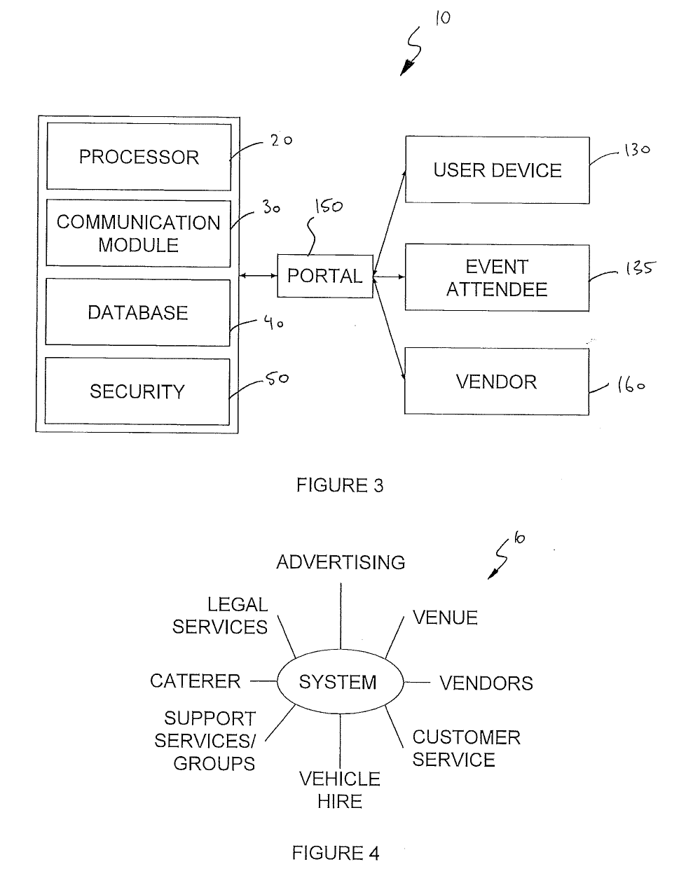

Referring to FIG. 3, there is depicted an embodiment of a schematic of the communication between a user device 130 and the hardware of the system 10. User device 130 is adapted to communicate via a portal 150 to the system 10. The portal can be an application (app), a website, or any other interface. Preferably, the portal is an online portal which allows a user to access the portal via the Internet such that the system can relay real-time data back to a user based on input data or options selected by the user. Preferably, the system 10 comprises at least one; processor 120, a communication means 130, database 140, and at least one security means 150. The database can be a volatile memory or a non-volatile memory device, such as a disk drive or a solid state drive which can store data. The security means can be at least one firewall, anti-virus or other data security means which restricts access to the system, preferably, to only those who have sufficient access rights.

The system 10 is adapted to communicate with at least one vendor 160 such that a user can order via the portal at least one good or service preferably related to an event. The system may also be adapted to communicate with at least one event invitee or attendee 135. If an event invitee or attendee 135 is to be communicated with, the user will be required to either manually enter contacts, upload contacts or synchronise with contact data. Contact data may be associated with an email account, an address book or any other digital record for retaining email or contact data.

Turning now to FIG. 4, there is shown a diagram of an embodiment of the system 10 which is in communication with; venues, vendors, customer service, vehicle hire, support services/groups, caterers, legal services and advertising. It will be appreciated that further goods and/or services may be offered by the system 10 which are related to an event.

Services or vendors which may be hired via the system may include at least one of the following; clowns, fairies, jumping castles, magician, animal farm, cleaners, Disc Jockeys, marquee hire, electrical equipment hire, electricity supply equipment, caterers, party hire goods, decorations, cakes, florists, children party venues, kids activity centres, restaurants, halls, clubs, limousine hire, private bus companies, party planners, invitations, portable toilets, gardeners/yard maintenance, swimming pool services, videos, videography hire, photographers, gift registries, major department stores, hairdressers, nail salons, makeup artists, portraits, child minders, nannies, baby sitters, resorts, reception halls, hotels, Airbnb™, travel agents, airlines, bands, orchestras, bottle shops, wedding boutiques, jewellers, bonbonniere, bridesmaids outfits, groomsman's outfits, baby stores, or any other desirable retail service.

Optionally, the system may be adapted to provide orders, instructions or otherwise communicate with department stores or shops associated with the system to order goods and/or services.

Suppliers (otherwise referred to as vendors) of goods and/or services can sign up to advertise and manage their profiles associated with the system. Managing profiles may allow for vendors to alter offered goods and services as well as provide coupons or discounts for products or advertise sales. Optionally, advertising for sales may incur an additional fee for promotion via the system.

In yet another embodiment, the memory planner or personalised memory book may be available for users to upload images, videos or comments regarding an event. The images, videos and/or comments may then be used to generate a memory book of the event. The memory book may be an online recourse or may be a printed book, in which links to media which is not printable, such as video, is provided. Fees may be associated with different formats of the memory book. A memorial page may have a limited predetermined time in which the memory planner is to be interacted with before being closed off to prevent invitees or authorised users from generating further comments or memories in the memory planner.

Examples of events to be arranged or booked via the system may include at least one of; funerals, weddings, birthdays, anniversaries, house warmings, baby showers, christenings, religious specific events, bar mitzvahs, bat mitzvahs divorce celebrations.

One tier of the system may provide for a subscription based system. The tier may be referred to as “funeral and beyond subscribers”. These subscribers may be institutes or users which may have a high rate of use for the system, such as event planners or nursing homes. The event planners may wish to use the system for booking birthdays, weddings or other such joyous events, Nursing homes may statistically require funeral services for persons who were living in the nursing home.

Other associated services may further be offered which relate to services to allow for attendees for an event, such as, pet kennels, airlines, child minders, nannies, baby sitters, resorts, car hire or the like.

The system may also be adapted to communication with publication services, such as magazines, newspapers, websites or blogs. The system may allow for publication via the publication services for death notification publications, obituaries, wedding notifications, birthday notifications or any other event notifications,

Venues may be booked via the system which relate to an event. Venues may include; funeral parlours, crematoriums, cemeteries, halls, clubs, pubs, serviced buildings, restaurants or parks. Booking a park may require council or government authorisation, and access to permit applications may be provided via the system or contact details for relevant authorities/governments may be provided.

Memorial items may be purchased through vendors, which may include; coffins, headstones, pods, lanterns, benches, statues, plaques or any other item with an inscription or to be used as a memorial token.

Loans may be provided via an approved financial institute, such as a bank or a credit union. The loans may be associated with the user of the system or may be applied for with assets from an estate of a deceased person if the event is a funeral.

In a further embodiment, if the event is a funeral the system provides for a pet care service or pet adoption service for the deceased. This may ensure that animals are looked after adequately or adopted out to families if the animals have not been willed to or adopted by others already.

Charity services of the system may also allow for donations to be provided from attendees to a charity of selection. This is of particular use when the event is for a fundraiser or other event to raise money. Donated or pledged money may be held in a trust account or in escrow until any requirements have been met in order to take the money collected.

In yet another embodiment, the system provides for a website which has a homepage. The homepage may provide a portal for a customer to sign up or login to the system. After a user is allowed access to the system, generally by signing up and subsequently logging in, the user may have access to a list of events. The list of events may be associated with events already booked by a user or attended by a user. Each event may optionally be associated with a memory book, in which the event and/or a person of the event can be recorded or written about. The memory book may be associated with media, such as photographs, video and/or comments.

The option to book an event may be accessed by the user to generate anew event or propose a new event to obtain a quote. The book an event option may include fields relating to at least one of; booking event details including a person of honour or reason for the event, booking details (personal details of person of honour, if any), booking event details (location of event), booking service funeral details (burial embellishments or decorations), booking service funeral details, book service notices (for public events), booking service notifications or invitations, booking service documents, booking service documents (bills or fees), book service aftercare (social events), book service aftercare (home services, such as cleaning or maintenance), book service aftercare (cemetery cleaning, flower services, etc.).

The system allows for booking of service payments for goods and/or services desired to be purchased. A history of goods and/or services may be viewed in the users profile if desired.

Suppliers or vendors may sign up to the system such that they can sell and/or promote goods. The supplier may sign up via a supplier login interface. The user may be provided with a number of vendor or supplier options, in relation to the goods and services required. The system may be adapted to display to a user a plurality of vendors, or the system may restrict the vendors displayed to a user. A plurality of vendors may be displayed to a user via a dropdown or other visual listing option. A search function may also be provided for vendors not associated with the system, and the system may apply a service or referral fee if a user wishes to purchase from a vendor not associated with the system.

A vendor may be associated with more than one type of event or may be used for a plurality of goods and services, otherwise referred to as ‘product listings’. The product listings may include fields relating to; supplier business categories, supplier list of purchases closed, supplier list of purchases open, supplier messages, supplier new message and supplier edit details. The supplier lists, if open, refer to goods in a cart or basket which have not been paid for. Conversely, if a supplier list is closed, the products have been purchased or are unavailable for purchase by a user.

The vendor may edit or amend listings based on product supply or may modify prices or other aspects of a product listing. The system preferably allows for a vendor and a user to communicate via a messaging service. The messaging service may allow for custom requests or quotes to be provided to a user.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

What is claimed is:

1. A system for arranging an event for at least one subject, wherein the system comprises:
an access portal configured to allow for a user to input data relating to;
predetermined personal information of the user, a theological preference of a subject, a location of the event on a predetermined date;
the access portal adapted to facilitate the user to make at least one purchase from at least one vendor for the event; and
wherein the system is configured to provide options for the at least one purchase relevant only to the combination of a theological preference and a location of the event in which the purchase is delivered relative to the date.

2. The system as claimed in claim 1, wherein the system allows wellbeing and healthcare services to be booked for at least one of; the user, a person associated with the subject and a family member of the subject.

3. The system as claimed in claim 1, wherein the options for purchase include options related to; advertising, a venue of the event, vehicle hire, a caterer, event specific goods and services, and legal services.

4. The system as claimed in claim 3, wherein the legal services includes probate services.

5. The system as claimed in claim 1, wherein the system allows only a predetermined vendor to offer goods and/or services to the user.

6. The system as claimed in claim 1, wherein a fee is charged to at least one of a user and a vendor to use the system.

7. The system as claimed in claim 1, wherein the access portal is at least one of a mobile application, a web portal, and an Internet webpage.

8. The system as claimed in claim 1, wherein the options for the at least one purchase includes a biodegradable product comprising at least one of the materials selected from the group of; bio degradable polymers, cardboard, paper, food products, bread, starch based materials, wax, cotton, and wool.

9. The system as claimed in claim 1, wherein ashes from a subject are used to form an embedded product.

10. The system as claimed in claim 9, wherein the embedded product is at least one of a statue and a toilet seat.

11. The system as claimed in claim 1, wherein the event is at least one event selected from the group of; funerals, weddings, birthdays, anniversaries, house warmings, baby showers, christenings, religious specific events, bar mitzvahs, bat mitzvahs and divorce celebrations.

12. A method for arranging an event for a subject, the method comprising the steps of;
uploading via a portal at least one data set for the location of the event and a predetermined date on which to have the event;
entering in the portal a theological preference of a subject to which the event is related to; and
selecting at least one purchase option for an event from at least one vendor, wherein the at least one purchase option is displayed to a user based on the location of the event and the theological preference of the subject.

13. The method as claimed in claim 12, wherein the method further includes the step of selecting an advertising option in relation to the event.

14. The method as claimed in claim 12 wherein the method further includes the step of arranging for an officiant to attend the event.

15. The method as claimed in claim 12, wherein the method further includes the step of hiring at least one vehicle for the event.

16. The method as claimed in claim 12, wherein the method further includes the step of purchasing at least one of; a casket or a site marker from a predetermined vendor.

17. The method as claimed in claim 12, further including the step of a user paying a usage fee to the system.

18. The method as claimed in claim 12, further including the step of a vendor paying a usage fee to the system.

19. The method as claimed in claim 12, further comprising the step of booking at least one wellbeing service for at least one of; a user, an invitee of the event and an attendee of the event.

20. The method as claimed in claim 12, wherein the event is selected from the group of; funerals, weddings, birthdays, anniversaries, house warmings, baby showers, christenings, religious specific events, bar mitzvahs, bat mitzvahs and divorce celebrations.
